(19) United States
(12) Patent Application Publication
(10) Pub. No.: US 2009/0184995 A1
(43) Pub. Date: Jul. 23, 2009

(54) LIQUID EJECTING APPARATUS AND LIQUID EJECTING METHOD

(75) Inventor: Toshiki USUI, Shiojiri-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/357,603

(22) Filed: Jan. 22, 2009

(30) Foreign Application Priority Data
Jan. 23, 2008 (JP) 2008-012963

(51) Int. Cl. B41J 29/377

(52) U.S. Cl. 347/18

(57) ABSTRACT

A liquid ejecting apparatus includes: a head which ejects a liquid in accordance with a driving signal; a driving signal generator which generates the driving signal; a sensor which detects the temperature of the head; and a controller which allows the head to wait the liquid ejection performed in accordance with the driving signal on the basis of the detection result of the sensor.

### BACKGROUND

1. Technical Field

The present invention relates to a liquid ejecting apparatus and a liquid ejecting method.

2. Related Art

As a liquid ejecting apparatus, there is known an ink jet printer (hereinafter, referred to as a printer) which ejects ink from a head by drive of driving elements in accordance with a driving signal. When a printing process continues to be performed for a long time, a driving signal generator which generates the driving signal may be overheated, thereby causing a trouble of the ink jet printer.

In order to solve this problem, there was suggested a method of providing a sensor in the driving signal generator and allowing the driving signal generator to wait generation of the driving signal, when a temperature detected by the sensor exceeds an allowable temperature (for example, see JP-A-2005-219462).

Heat generated in the driving signal generator causes a temperature of the head within the liquid ejecting apparatus to increase. When the temperature of the head excessively increases, a problem occurs in that a failure in ink ejection occurs.

### SUMMARY

An advantage of some aspects of the invention is that it provides a technique capable of suppressing an increase in temperature of a head.

According to an aspect of the invention, there is provided a liquid ejecting apparatus including: a head which ejects a liquid in accordance with a driving signal; a driving signal generator which generates the driving signal; a sensor which detects the temperature of the head; and a controller which allows the head to wait the liquid ejection performed in accordance with the driving signal on the basis of the detection result of the sensor.

Other aspects of the invention are apparent from the specification and the accompanying drawings of the invention.

### BRIEF DESCRIPTION OF THE DRAWINGS

The invention will be described with reference to the accompanying drawings, wherein like numbers reference like elements.

FIG. 1 is a block diagram illustrating the overall configuration of a printer according to an embodiment.

FIG. 2A is a perspective view illustrating the printer and FIG. 2B is a sectional view illustrating the printer.

FIG. 3 is a diagram illustrating a driving signal generating circuit.

FIG. 4 is a diagram illustrating the driving signal generating circuit and a head driving circuit.

FIG. 5 is a timing chart illustrating respective signals.

FIG. 6 is a diagram illustrating a voltage variation of a first driving pulse and a current variation.

FIG. 7A is a top view illustrating the printer and FIG. 7B is a sectional view illustrating the printer.

FIG. 8 is a diagram illustrating transistors, a heat sink, a fan provided on a board.

FIG. 9 is a diagram illustrating a relay board of the head.

FIG. 10 is a flowchart illustrating a waiting process according to Example 1.

FIG. 11 is a condition table of the waiting process according to Example 1.

FIG. 12 is a flowchart illustrating a waiting process according to Example 2.

FIG. 13 is a condition table of the waiting process according to Example 2.

FIG. 14 is a flowchart illustrating a waiting process according to Example 3.

FIG. 15A is a waiting condition table of a head temperature for the waiting process and FIG. 15B is a waiting condition table of transistor temperature.

### DESCRIPTION OF EXEMPLARY EMBODIMENTS

### Overview of Disclosure

Aspects described below are apparent from disclosure of the specification and disclosure of the accompanying drawings of the invention.

According to an aspect of the invention, a liquid ejecting apparatus includes: a head which ejects a liquid in accordance with a driving signal; a driving signal generator which generates the driving signal; a sensor which detects the temperature of the head; and a controller which allows the head to wait the liquid ejection performed in accordance with the driving signal on the basis of the detection result of the sensor.

According to the liquid ejecting apparatus having the above-described configuration, when the driving signal generator generates the driving signal and thus heat is generated, a problem may occurs in that the head within the liquid ejecting apparatus (within a case) may be also heated together with the driving signal generator. However, by allowing the sensor to detect a head temperature and waiting the liquid ejection on the basis of the detection result, it is possible to restrain excessive increase in the head temperature. In consequence, it is possible to prevent ejection failure of the head and breakdown of the head.

The liquid ejecting apparatus may further include a fan which cools the driving signal generator heated due to the generation of the driving signal. The fan inhales air from the outside of the liquid ejecting apparatus.

According to the liquid ejecting apparatus, the driving signal generator can be cooled thanks to air having temperature lower than the inside air of the liquid ejecting apparatus heated due to the driving signal generator. In consequence, it is possible to restrain the increase in the head temperature affected due to the heat generation of the driving signal generator.

The liquid ejecting apparatus may further include a generator sensor which detects the temperature of the driving signal generator. The controller allows the head to wait the liquid ejection performed in accordance with the driving signal on the basis of the detection result of the sensor and the detection result of the generator sensor.

According to the liquid ejecting apparatus, it is possible to restrain increase in the temperature of the head and restrain increase in the temperature of the driving signal generator. In consequence, it is possible to prevent the ejection failure of the head and the breakdown of the head. Moreover, it is possible to prevent a damage to the driving signal generator.

In the liquid ejecting apparatus, the controller may determine first waiting time, which is time for waiting the liquid ejection from the head performed in accordance with the driving signal, on the basis of the detection result of the sensor and may determine second waiting time on the basis of the detection result of the generator sensor. In addition, the controller may allow the head to wait the liquid ejection performed in accordance with the driving signal only for longer time of the first waiting time and the second waiting time.

According to the liquid ejecting apparatus, it is possible to restrain the increase in the temperature of the head and restrain the increase in the temperature of the driving signal generator. In consequence, it is possible to prevent the ejection failure of the head and the breakdown of the head. Moreover, it is possible to prevent a damage to the driving signal generator.

In the liquid ejecting apparatus, the controller may allow the head to wait the liquid ejection performed in accordance with the driving signal, when the detection result of the generator sensor exceeds a threshold value based on the detection result of the sensor.

According to the liquid ejecting apparatus, it is possible to restrain the increase in the temperature of the head and restrain the increase in the temperature of the driving signal generator. In consequence, it is possible to prevent the ejection failure of the head and the breakdown of the head. Moreover, it is possible to prevent a damage to the driving signal generator.

In the liquid ejecting apparatus, the threshold value may become lower as the detection result of the sensor becomes higher.

According to the liquid ejecting apparatus, when the temperature of the head increases, it is easy to allow the head to wait the liquid ejection performed in accordance with the driving signal. Accordingly, it is possible to restrain the increase in the temperature of the driving signal generator and thus restrain the increase in the temperature of the head.

In the liquid ejecting apparatus, the generation of the driving signal by the driving signal generator may be interrupted, when at least one of the detection result of the sensor and the detection result of the generator sensor exceeds a limit value.

According to the liquid ejecting apparatus, it is possible to surely prevent the ejection failure of the head or the breakdown of the head, and prevent the breakdown of the driving signal generator.

According to another aspect of the invention, in a liquid ejecting apparatus which includes a head ejecting a liquid in accordance with a driving signal, a driving signal generator generating the driving signal, and a sensor detecting the temperature of the head, a liquid ejecting method includes: detecting the temperature of the head and allowing the head to wait the liquid ejection performed in accordance with the driving signal on the basis of the detection result of the sensor.

According to the liquid ejecting method, it is possible to restrain excessive increase in the head temperature. In consequence, it is possible to prevent the ejection failure of the head and the breakdown of the head. By preventing the ejection failure, it is possible to prevent an image from deteriorating.

### Configuration of Ink Jet Printer

Hereinafter, according to an embodiment, an ink jet printer will be described as an example of a liquid ejecting apparatus and a serial type printer (printer 1) will be described as an example of the ink jet printer.

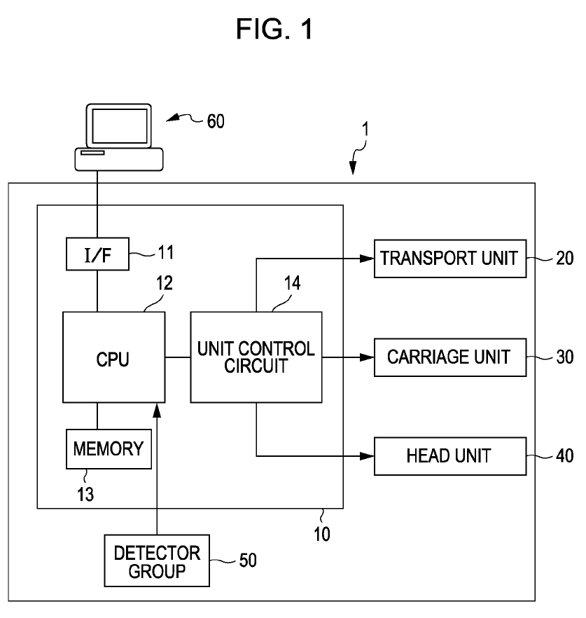

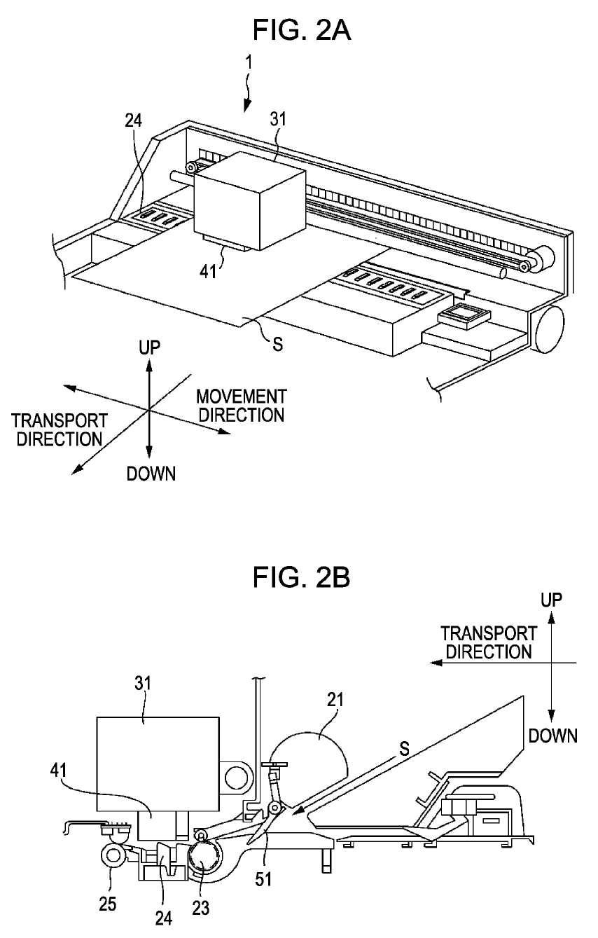

FIG. 1 is a block diagram illustrating the overall configuration of a printer 1 according to the embodiment. FIG. 2A is a perspective view illustrating the printer 1 and FIG. 2B is a sectional view illustrating the printer 1. The printer 1 receiving print data from a computer 60 as an external apparatus allows a controller 10 to control units (a transport unit 20, a carriage unit 30, and a head unit 40) and forms an image onto a sheet S (medium). In addition, a detector group 50 detects statuses of the printer 1 and the controller 10 controls the units on the basis of the detection result.

The controller 10 is a unit which controls the printer 1. An interface unit 11 is a unit which transmits and receives data between the computer 60 as the external apparatus and the printer 1. A CPU 12 is an arithmetic processing unit which controls the printer 1 on the whole. A memory 13 is a unit which ensures an area where programs of the CPU 12 are stored and a work area. The CPU 12 allows a unit control circuit 14 to control units.

The transport unit 20 is a unit which transports the sheet S by a predetermined transport distance in a transport direction in a printing process after transporting the sheet S to a printable location. The transport unit 20 includes a sheet feeding roller 21, a transport motor 22, a transport roller 23, a platen 24, and a sheet discharging roller 25. The sheet S on which the printing process is performed is transported to the transport roller 23 by rotation of the sheet feeding roller 21. When a sheet detecting sensor 51 detects the location of a front end of the sheet S transported from the sheet feeding roller 21, the controller 10 positions the sheet S to a print initiation location by rotating the transport roller 23. When the sheet S is positioned to the print initiation location, at least some nozzles of a head 41 are opposed to the sheet S.

The carriage unit 30 is a unit which moves the head 41 in a direction (hereinafter, referred to as a movement direction) intersecting the transport direction and includes a carriage 31 and a carriage motor 32.

The head unit 40 is a unit which ejects ink onto the sheet S and includes the head 41 (one head) and a head driving circuit 42 driving the head 41. A plurality of nozzles ejecting ink is formed on a lower surface of the head 41. Each of the nozzles is provided with an ink chamber (not shown) storing ink and a driving element (piezo element) ejecting the ink by variation in the volume of the ink chamber.

The serial type printer 1 repeatedly performs a dot forming process of forming dots onto the sheet S by continuously ejecting the ink from the head 41 being moving in the movement direction and a transport process of transporting the sheet S in the transport direction in an alternative manner. Then, dots are formed at locations different from the locations of the dots formed by the previous dot forming process to complete an image.

### Driving of Head

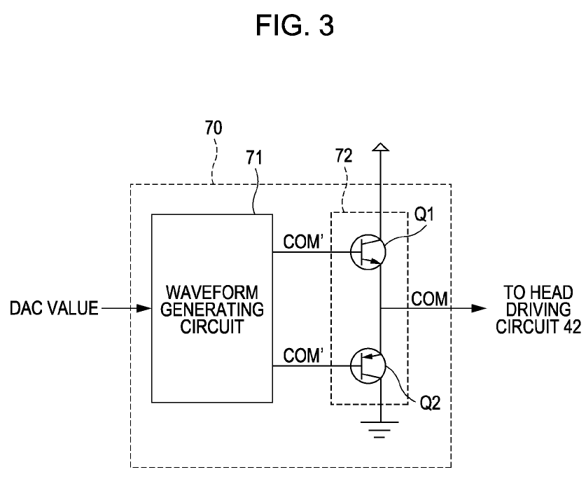

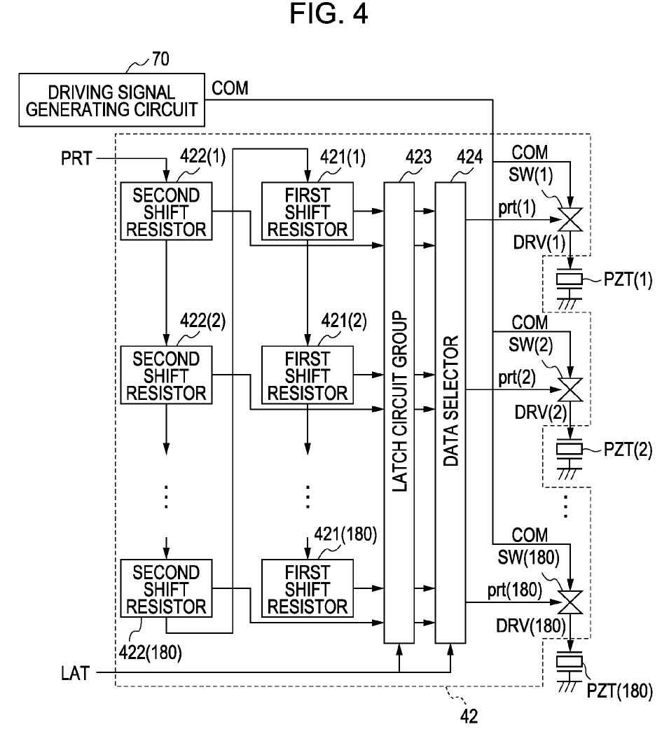

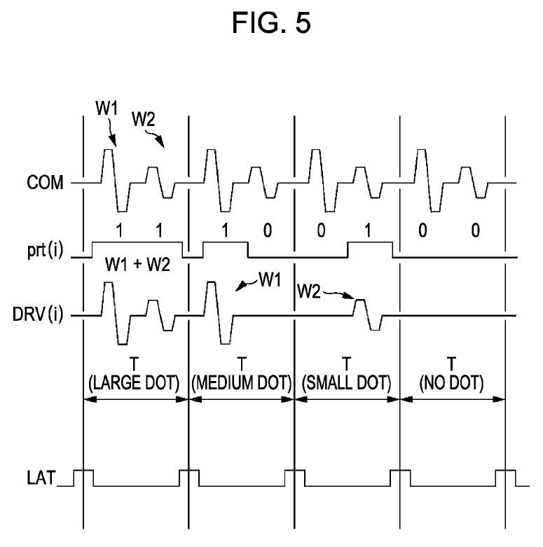

FIG. 3 is a diagram illustrating a driving signal generating circuit 70. FIG. 4 is a diagram illustrating the driving signal generating circuit 70 and a head driving circuit 42. FIGS. 3 and 4 show that the piezo elements corresponding to the respective nozzles are operated by the head driving circuit 42. FIG. 5 is a timing chart illustrating respective signals.

### Driving Signal Generating Circuit

As shown in FIG. 3, the driving signal generating circuit 70 (corresponding to a driving signal generator) includes a waveform generating circuit 71 and a current amplifying circuit 72 and generates a driving signal COM to be commonly used for a certain nozzle group (piezo elements PZT). First, the waveform generating circuit 71 generates a voltage waveform signal COM′ (waveform information on analog signal) which is a fundamental of the driving signal COM on the basis of a DAC value (waveform information on a digital signal). In addition, the current amplifying circuit 72 amplifies the current of the voltage waveform signal COM′ and outputs it as the driving signal COM.

The current amplifying circuit 72 includes an increase transistor Q1 (NPN-type transistor) which operates when the voltage of the driving signal COM increases and a decrease transistor Q2 (PNP-type transistor) which operates when the voltage of the driving signal COM decreases. In the increase transistor Q1, a collector is connected to a power source and an emitter is connected to an output signal line of the driving signal COM. In the decrease transistor Q2, a collector is connected to a grounding (earth) line and an emitter is connected to the output signal line of driving signal COM.

When the voltage waveform signal COM′ from the waveform generating circuit 71 causes the increase transistor Q1 to be turned ON, the driving signal COM increases and the piezo elements PZT are electrically charged. On the other hand, when the voltage waveform signal COM′ causes the decrease transistor Q2 to be turned ON, the driving signal COM decreases and the piezo elements PZT are electrically discharged. In this way, as shown in FIG. 5, the driving signal COM having a first driving pulse W1 and a second driving pulse W2 within a repetition period T is generated.

### Head Driving Circuit

The head driving circuit 42 includes 180 first shift resistors 421, 180 second shift resistors 422, a latch circuit group 423, a data selector 424, and 180 switches SW. The head driving circuit 42 corresponds to a nozzle group constituted by 180 nozzles. Each numeral of a parenthesis in the drawing indicates a nozzle number corresponding to each member (or each signal).

First, print signals PRT are input to the 180 first shift resistors 421 and then input to the 180 second shift resistors 422. As a result, the print signals PRT transmitted in serial are converted into print signal PRT (i) which are 180 2-bit data. The print signals PRT (i) are signals corresponding to 1-pixel data assigned to a nozzle #i.

When an initial rise pulse of a latch signal LAT is input to the latch circuit group 423, 360 data of the shift resistors are latched in the latch circuit group 423. When the initial rise pulse of the latch signal LAT is input to the latch circuit group 423, the initial rise pulse of the latch signal LAT is also input to the data selector 424 and then the data selector 424 become an initial state.

The data selector 424 selects the 2-bit print signal PRT (i) corresponding to the nozzle #i from the latch circuit group 423 before the latching (before the initial state), and outputs a switch control signal prt (i) in response to the print signal PRT (i) to each switch SW (i).

The switch control signal prt (i) causes the switch SW (i) corresponding to a piezo element PZT (i) to be turned ON or OFF. In addition, in on and off operations of the switch, the driving signal COM transmitted from the driving signal generating circuit 70 is applied to or cut off from the piezo elements (DRV (i)) to eject ink or not to eject ink from the nozzle #i.

### Ink Ejection

For example, when a level of the switch control signal prt (i) is “1”, the switch SW (i) is turned ON, the driving pulses (W1 and W2) of the driving signal COM are passed without any change, and the driving pulses are applied to the piezo element PZT (i). When the driving pulses are applied to the piezo element PZT (i), the piezo element PZT (i) is deformed in accordance with the driving pulses, an elastic film (side wall) partitioning a part of the ink chamber is deformed, and a predetermined amount of ink stored in the ink chamber is ejected from the nozzle #i. Alternatively, when the level of the switch control signal prt (i) is “0”, the switch SW (i) is turned OFF and thus the driving pulses of the driving signal COM are cut off.

In this embodiment, the print signal prt (i) for one pixel is 2-bit data and one pixel is expressed as four gray scales, that is, “formation of large dots”, “formation of medium dots”, “formation of small dots”, and “no formation of dots”. In FIG. 5, when the switch control signal prt (i) is “11”, the first driving pulse W1 and the second driving pulse W2 are applied to the piezo element PZT (i). In addition, by applying two driving pulses to the piezo element PZT (i), an amount of ink corresponding to the large dots is ejected from the nozzle #i to form the large dots. Likewise, when the switch control signal prt (i) is “10”, the medium dots are formed. When the switch control signal prt (i) is “01”, the small dots are formed. In addition, when the switch control signal prt (i) is “00”, any driving pulse is not applied to the piezo element PZT (i). Therefore, the piezo element PZT (i) is not deformed and any dot is not formed.

### Power Consumption of Transistor

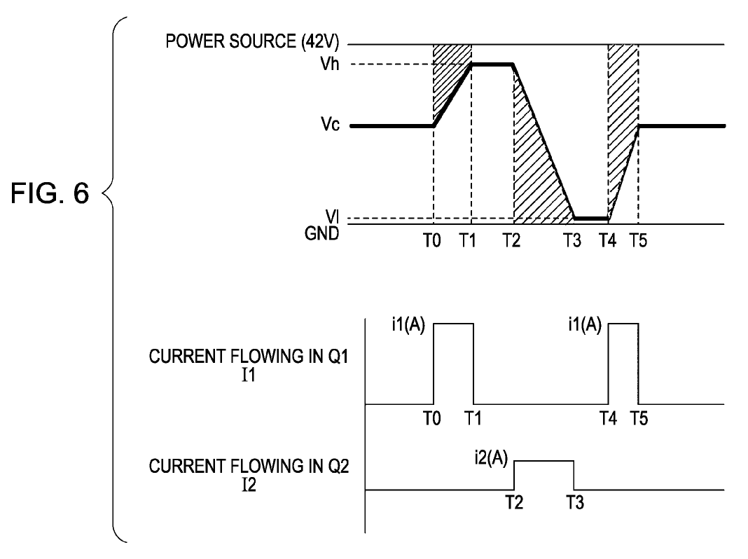

FIG. 6 is an explanatory diagram illustrating a voltage variation of the first driving pulse W1 included in the driving signal COM and a variation in current flowing in the transistors Q1 and Q2. Even when the waveform generating circuit 71 generates the voltage waveform signal COM′ in accordance with the DAC value and the voltage waveform signal COM′ is input to the transistor (current amplifying circuit 72) (see FIG. 3) and when the data of the switch control signal prt (i) is “10” (see FIG. 5), for example, only the first driving signal W1 is applied to the piezo elements and only current used to generate the first driving pulse W1 flows in the transistor. That is, power consumption P of the transistor is different depending on the driving pulse applied to the piezo elements. Hereinafter, the power consumption P of the transistor upon applying the first driving pulse W1 to the piezo elements PZT will be described.

The driving signal generating circuit 70 maintains intermediate driving voltage Vc until time T0. In addition, the driving signal generating circuit 70 increases the voltage from the intermediate driving voltage Vc to the highest driving voltage Vh between a period from time T0 to time T1. At this time, the increase transistor Q1 is turned ON and thus current i1 (A) flows in the increase transistor Q1. In addition, the piezo elements PZT expand the volume of the ink chambers.

Subsequently, after the driving signal generating circuit 70 maintains the highest driving voltage Vh until time T2, the driving signal generating circuit 70 decreases the voltage from the highest driving voltage Vh to the lowest driving voltage V1 between a period from time T2 to time T3. At this time, the decrease transistor Q2 is turned ON, and thus current i2 (A) flows in the decrease transistor Q2. The ink chambers are contracted by the piezo elements PZT. A variation in the volume of the ink chambers causes the ink to be ejected from the nozzles.

Finally, the driving signal generating circuit 70 maintains the lowest driving voltage V1 until time T4 and increases the voltage from the lowest driving voltage V1 to the intermediate driving voltage Vc in a period from time T4 to time T5. At this time, the increase transistor Q1 is turned ON, and thus the current i1 (A) flows in the increase transistor Q1. In addition, the piezo elements PZT expand the volume of the ink chambers to return the volume of the ink chambers to a reference volume corresponding to the intermediate driving voltage Vc.

In this way, when the first driving pulse W1 is applied to the piezo elements, the current flows in the increase transistor Q1 and the decrease transistor Q2 and thus power is consumed.

The current i1 (A) flows in the increase transistor Q1 in a period from time T0 to time T1 and in a period from time T4 to time T5. Therefore, the power consumption at certain time T in the period from time T0 to time T1 or the period from time T4 to time T5 is obtained by multiplying a difference between a potential of a driving signal DRV at the time T and a power source potential (42 V) by the current i1 (A). A total sum of the power consumption in the period from time T0 to time T1 and the power consumption in the period from time T4 to time T5 is a power consumption q1 (Wh) of the increase transistor Q1 upon applying the first driving pulse W1 to the piezo elements PZT.

Likewise, the current i2 (A) flows in the decrease transistor Q2 in the period from time T2 to time T3. Therefore, the power consumption at certain time T in the period from time T2 to time T3 is obtained by multiplying a difference between a potential of a driving signal DRV at the time T and a GND potential by the current i2 (A). A total sum of the power consumption in the period from the time T2 to the time T3 is a power consumption q2 (Wh) of the decrease transistor Q2 upon applying the first driving pulse W1 to the piezo elements PZT.

That is, the power consumption upon applying the first driving pulse W1 to one piezo element PZT is q1+q2 (Wh) obtained by adding the power consumption q1 (Wh) of the increase transistor Q1 and the power consumption q2 (Wh) of the decrease transistor Q2. In addition, since time (time from T0 to T5 in FIG. 6) necessary when the driving pulse W is applied to the piezo elements PZT is very short, hereinafter, the power consumption (q1+q2 (Wh)) is referred to as a power consumption P of the transistor obtained at the moment in which the first driving pulse W1 is applied to the piezo elements PZT.

### Heat Generation and Wait Operation of Transistor and Head

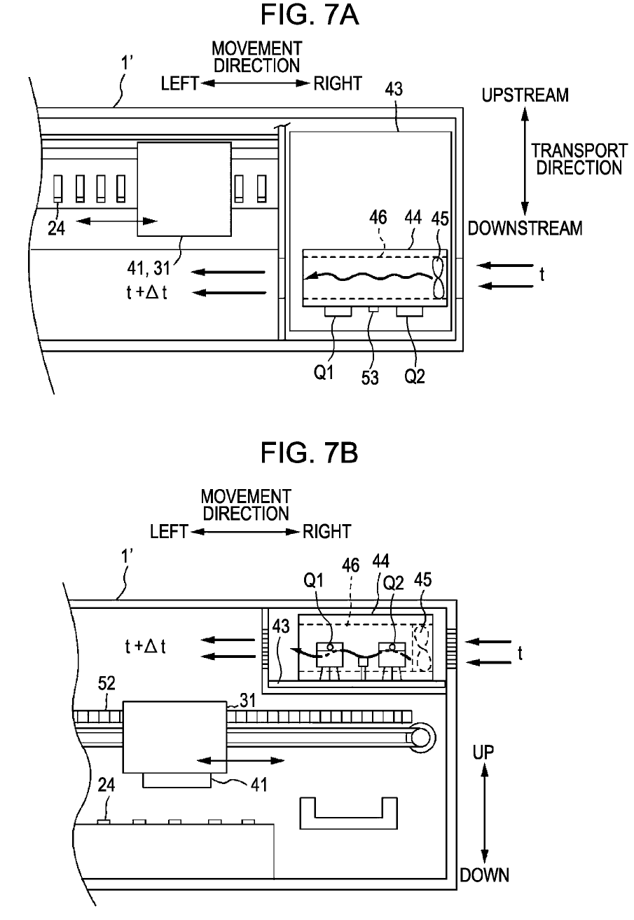

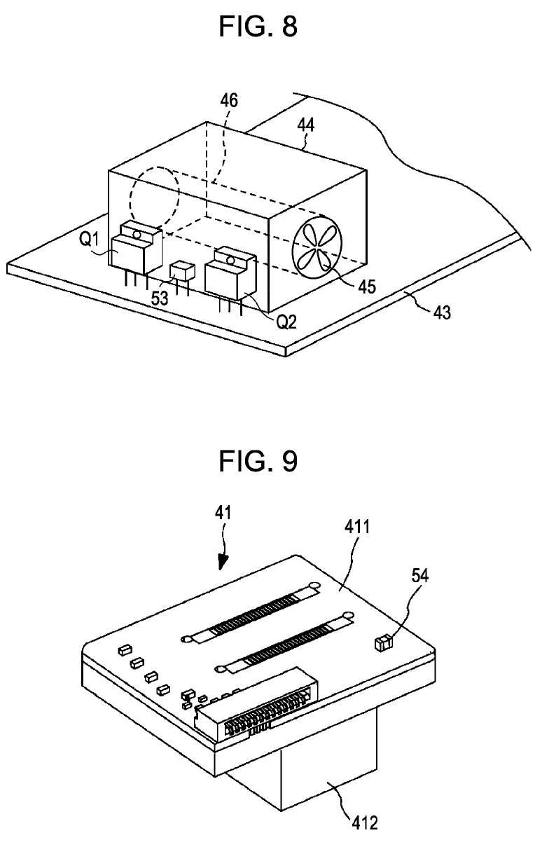

FIG. 7A is a top view illustrating the printer 1 and FIG. 7B is a sectional view illustrating the printer 1. FIG. 8 is a diagram illustrating transistors Q, a heat sink 44, and a fan 45 provided on a board 43 of the driving signal generating circuit 70. The board 43 of the driving signal generating circuit 70 is located on a right side in the movement direction in the printer 1 and in a home position of the head 41.

There is a junction (not shown) in a semiconductor constituted by the transistors Q1 and Q2 of the driving signal generating circuit 70. When the transistors Q1 and Q2 generate the driving signal COM, the junction generates heat. The transistors may break down, when the temperature of the transistors become high due to the heat generation. In order to avoid this problem, the heat sink 44 (heat radiation member) is provided in contact with the pair of transistors Q1 and Q2, as shown in FIG. 8. The heat sink 44 radiates the heat generated by the transistors Q toward the outside. Therefore, the heat sink 44 prevents temperature of the transistors Q from rising.

The heat sink 44 according to this embodiment is provided with a hollow space 46 having a cylindrical shape. Thanks to providing the hollow space 46, the surface area of the heat sink 44 is increased, thereby increasing an amount of heat to be radiated to the air by an amount corresponding to the increased surface area. The fan 45 is provided on one of sides of the heat sink 44 which are an entrance of the hollow space 46. By forcing the fan 45 to pass the air through the hollow space 46 of the heat sink 44, the heat of the heat sink 44 is easily delivered to the air. As a result, a cooling effect on the heat sink 44 and the transistors Q is improved.

The board 43 equipped with the heat sink 44 and the transistors Q and head 41 are surrounded by an outer frame 1′ of the printer 1. That is, the heat sink 44, the transistors Q, and the head 41 are within the same case (within the outer frame 1′ of the printer 1), as shown in FIGS. 7A and 7B. Therefore, when the heat is generated in the transistors due to the generation of the driving signal, it is easy for the heat to heat the inside of the printer 1 (inside of the outer frame 1′). For that reason, during use of the printer 1, a temperature t+Δt of the inside of the printer 1 is higher than an outside air temperature t of the printer 1. In particular, the ambient temperature of the transistors Q is higher than the outside air temperature t.

For that reason, the fan 45 according to this embodiment “inhales” the outside air of the printer 1 into the inside. Then, the fan 45 passes the air having a relatively low temperature t outside the printer 1 through the inside of the hollow space 46 of the heat sink 44. Alternatively, when the fan provided in the heat sink “exhausts” the inside air of the printer 1 to the outside, the air having the relatively high temperature t+Δt passes through the inside of the hollow space 46. That is, the method of allowing the fan 45 according to this embodiment to inhale the outside air drops the temperature of the heat sink 44 more than the method of exhausting the inside air does. Therefore, since it is possible to further drop the temperature of the junction of the transistors by inhaling the outside air according to this embodiment, the breakdown of the transistors caused due to high temperature can be prevented.

In this case, by allowing a blowing direction of the fan 45 to be oriented from the outside to the inside of the printer 1, the air of the temperature t+Δt heated due to the heat generated by the transistors flows inside the printer 1. In consequence, a head temperature of the head 41 increases due to the heated air flowing inside the printer 1 in which the head 41 is located. When the head temperature excessively increases, ejection failure such as dot omission or travel curve may occur or the head may break down. As shown in FIG. 7A, the heat sink 44 and the fan 45 deviate from the head 41 in the transport direction. Moreover, as shown in FIG. 7B, the heat sink 44 and the fan 45 are disposed above the head 41. With such a configuration, the heated air is prevented from blowing from the fan 45 to the head 41, but the heated air flowing in the vicinity of the head 41 causes the head temperature to increase.

In a printer in which a transistor and a head are disposed in the same case in addition to the printer 1 in which the fan 45 inhales the outside air and thus the heated air flows in the head 41 according to this embodiment, heat generated by the transistors heats the inside of the printer 1, thereby increasing the head temperature. In addition, if it is designed to allow the transistor to be away from the head so that the heat generated due to the transistor does not affect the head, the size of the printer may be increased.

That is, since the head temperature excessively increases due to the influence of the heat generated due to the transistors when the driving signal generating circuit 70 generates the driving signal, the ejection failure may occur or the head may break down. In particular, when the fan 45 inhales the outside air of the printer toward the inside in order to improve the cooling effect of the heat sink as in the printer 1 according to this embodiment, it is easy to increase the head temperature. Moreover, when a printing process is performed for a long time, it is difficult for the heat sink 44 or the fan 45 to prevent the heat generated due to the transistors. Therefore, the temperature of the junction of the transistors may exceed a limit temperature (for example, 125° C.), thereby breaking down the transistors.

In order to avoid this problem, an object of this embodiment is to prevent an increase in the temperature of the transistors Q1 and Q2 and the temperature of the head 41, and the temperature of the transistors and the temperature of the head are managed by a sensor. Therefore, the breakdown of the transistors (junction) and the ejection failure of the head 41 caused due to the high temperature are prevented.

As shown in FIG. 8, the temperature of the transistors is managed by a transistor sensor 53 (corresponding to a generator sensor) provided on the board 43 of the driving signal generating circuit 70. The controller 10 (corresponding to a controller) manages a temperature detected by the transistor sensor 53 as “a transistor temperature Tt” to prevent the breakdown of the transistors.

FIG. 9 is a diagram illustrating a relay board 411 of the head 41. The relay board 411 is provided above the nozzle surface 412 of the head 41. When a signal or the like from a head control unit (not shown) is transmitted to the driving element and the like through the relay board 411, the ink is ejected from the nozzles. The relay board 411 is provided with a head sensor 54 (corresponding to a sensor) managing the temperature of the head 41. The controller 10 manages a temperature detected by the head sensor 54 as “a head temperature Th” to prevent occurrence of the ejection failure. In addition, the head sensor 54 may be used to adjust the voltage of the driving signal COM. Since the viscosity of ink is different depending on an ambient temperature, a voltage value of the driving signal COM is configured to be adjusted on the basis of the detection result of the head sensor 54 to eject constant ink irrespective of the ambient temperature.

In this embodiment, in order to prevent the breakdown of the transistors beforehand, an allowable temperature is set. Then, when the transistor temperature Tt exceeds the allowable temperature, it is possible to allow the driving signal generating circuit 70 to wait the generation of the driving signal COM. In addition, when the transistor temperature Tt reaches a temperature (limit temperature) at which the transistors may break down if the printing process continues to be performed, the generation of the driving signal COM by the driving signal generating circuit 70 is interrupted. In this way, by temporarily pausing or interrupting the generation of the driving signal COM, it is possible to restrain the temperature of the transistors from increasing and prevent the transistors from breaking down.

Likewise, in order to prevent the ejection failure or the breakdown of the head beforehand, an allowable temperature is set. Then, when the head temperature Th exceeds the allowable temperature, it is possible to allow the driving signal generating circuit 70 to wait the generation of the driving signal COM. In addition, when the head temperature Th reaches a temperature (limit temperature) at which the ejection failure surely occurs if the printing process continues to be performed, the generation of the driving signal COM by the driving signal generating circuit 70 is interrupted. In this way, by temporarily pausing or interrupting the generation of the driving signal COM, it is possible to restrain the transistor temperature Tt from increasing. Moreover, by restraining the transistor temperature Tt from increasing, it is possible to reduce the temperature of the air passing through the inside of the hollow space 46 of the heat sink 44 by the fan 45 and flowing in the inside of the printer where the head 41 is located. As a result, it is possible to restrain the head temperature Th from increasing and prevent the ejection failure or the breakdown of the head 41.

That is, by allowing the driving signal generating circuit 70 to wait or interrupt the generation of the driving signal (wait to eject the liquid from the head in accordance with the driving signal or interrupt the generation of the driving signal from the driving signal generator) on the basis of the head temperature Th and the transistor temperature Tt, the breakdown of the transistors or the ejection failure and the breakdown of the head are prevented. Hereinafter, a process of waiting or interrupting the generation of the driving signal is referred to as “a waiting process”.

The two transistors Q1 and Q2 provided on the board 43 of the driving signal generating circuit 70 are surrounded by the case. In addition, the transistor sensor 53 is provided between the cases of the two transistors Q1 and Q2 (see FIG. 8). Therefore, the transistor temperature Tt detected by the transistor sensor 53 is an ambient temperature of the junction of the two transistors Q1 and Q2 generating heat.

A relation between a temperature Tj of the junction of the transistors and the transistor temperature Tt can be expressed by the following expression:

Tj=Tt+Toff+θjc×P,

where Toff is a temperature difference caused due to heat loss generated from the transistor sensor 53 to the case of the transistors, θjc×P is a temperature difference caused due to heat loss generated from the case to the junction of the transistors, θjc is a heat resistance (° C./W) between the junction and the case, and P is a power consumption (W) generated upon applying the driving signal COM from the transistors to the piezo elements.

This expression explains that it is easier for the transistors to break down, when the power consumption P of the transistors is large even though the transistor temperature Tt is the same. Therefore, in consideration of this fact, it is preferable that the allowable temperature (threshold value) of the transistor temperature Tt for existence or non-existence of the waiting process is determined.

When the head temperature Th or the transistor temperature Tt exceeds the allowable temperature and the driving signal generating circuit 70 completely waits the generation of the driving signal. Then, the nozzles may be clogged, since the viscosity of the ink is increased in the vicinity of the nozzles. In order to avoid this problem, it is necessary to normally eject a liquid from the nozzles by performing a recovery process such as a flushing process after the waiting process. Therefore, when the waiting process is performed in a state where the head temperature Th or the transistor temperature Tt exceeds the allowable temperature, the driving signal generating circuit 70 may generate a driving signal for minute vibration for allowing meniscus to minutely vibrate so as not to eject ink. The power consumption P is smaller in the driving signal for minute vibration than in the driving signal (the driving pulses W1 and W2 in FIG. 5) for ink ejection. For this reason, an increase ratio of the transistor temperature can be reduced upon generating the driving signal for minute vibration more than upon generating the driving signal for ink ejection in a printing process. In this way, it is possible to prevent the transistor from breaking down. In addition, during interrupting the printing process, the driving signal may not be completely generated and the driving signal for minute vibration may be generated. That is, in this embodiment, the driving signal generating circuit waits or interrupts the generation of the driving signal for ink ejection, when the head temperature Th or the transistor temperature Tt exceeds the allowable temperature.

### Waiting Process:

### EXAMPLE 1

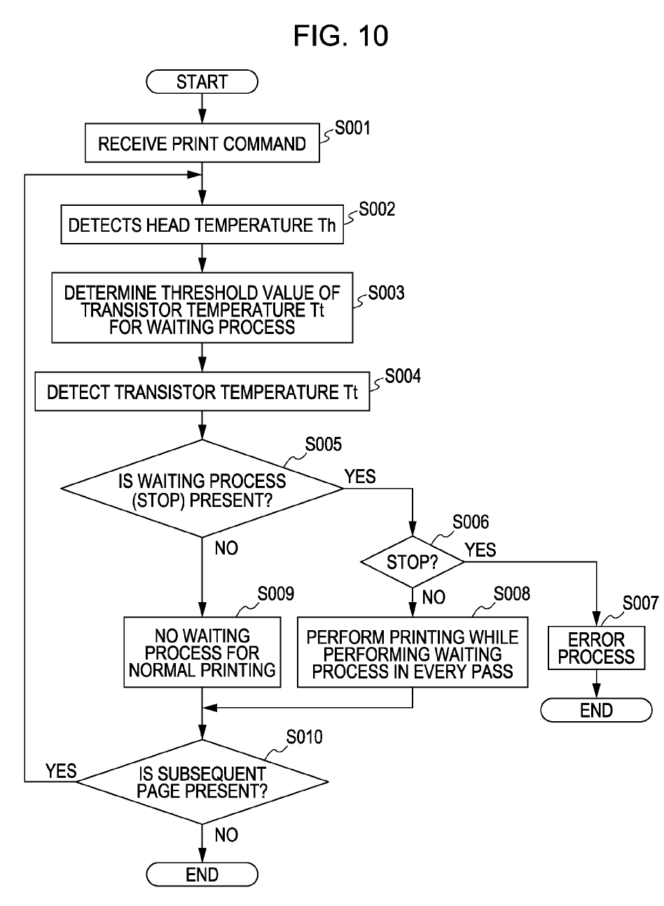

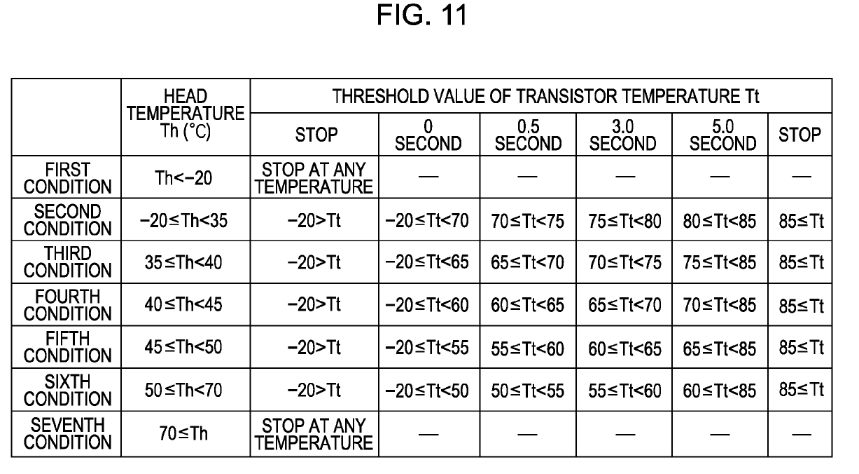

FIG. 10 is flowchart illustrating a waiting process according to Example 1. FIG. 11 is a condition table of the waiting process according to Example 1. In Example 1, the transistor temperature Tt and a threshold value are compared to each other to determine whether to perform the waiting process. In addition, the threshold value is determined by the head temperature Th. As shown in FIG. 11, a threshold value condition of the transistor temperature Tt for the waiting process is classified into seven types (from a first condition to a seventh condition) according to the head temperature Th. That is, the threshold value of the transistor temperature Tt used to determine whether to perform the waiting process is different depending on the head temperature Th. In addition, time at which the waiting process is performed is different according to the transistor temperature Tt.

A sequence of the printing process will be described according to Example 1. When the controller 10 receives a print command (S001), the head sensor 54 detects the head temperature Th (S002). The threshold value of the transistor temperature Tt for the waiting process is determined on the basis of the detected head temperature Th and the condition table (see FIG. 11) of the waiting process (S003). That is, it is determined which condition is suitable among a first condition to a seventh condition for the head temperature Th. For example, when the head temperature Th is 42° C., a fourth condition is determined as a threshold value condition of the transistor temperature Tt. Therefore, “−20, 60, 65, 70, and 85” are determined as the threshold values for the existence or non-existence of the waiting process or the respective waiting time. Subsequently, the transistor temperature Tt is detected (S004).

It is determined whether the driving signal generating circuit 70 performs the waiting process in accordance with the threshold of the transistor temperature Tt having just been determined on the basis of the head temperature Th (S005). When it is not necessary to perform the waiting process (S005→No), a normal printing process is performed (S009).

Alternatively, when the generation of the driving signal for ink ejection is waited (S005→Yes and S006→No), the printing process is performed while temporarily waiting (stopping) the generation of the driving signal for ink ejection in every pass in which the head 41 moves in the movement direction one time. The waiting time in every pass is determined not by the condition table of FIG. 11 but by the transistor temperature Tt.

When the transistor temperature Tt is below a temperature (−20° C.) of a use environment or above a limit temperature (85° C., corresponding to a limit value) at which the transistors break down, the printing process is stopped to perform an error process (S007). The error process refers to a process in which the controller 10 transmits error information to the computer 60 and then computer 60 displays the fact that an error occurs in the printing process on a display device, for example.

After the printing process corresponding to one page ends, it is checked whether data for a subsequent page is present (S010). When the data for the subsequent page is present (S010→Yes), it is determined again whether the waiting process is necessary, on the basis of the head temperature Th and the transistor temperature Tt to perform the printing process. Alternatively, when the data for the subsequent page is not present (S010→No), the printing process ends.

For example, when the detected head temperature Th is 37° C., a third condition is determined as the threshold value condition of the transistor temperature Tt for the waiting process. That is, “−20, 65, 70, 75, and 85” are determined as the threshold values. When the detected transistor temperature Tt is 62° C., the waiting process is not performed and the normal printing process is performed. Alternatively, when the transistor temperature Tt is 72° C., the printing process is performed while waiting the generation of the driving signal for ink ejection for 3 seconds in every one time pass. Alternatively, when the head temperature Th is 42° C. and the detected transistor temperature Tt is 62° C., the printing process is performed while waiting the generation of the driving signal for ink ejection for 0.5 second in every one time pass.

That is, according to Example 1, the threshold values of the transistor temperature Tt for the waiting process are different due to the head temperature Th. Therefore, even though the transistor temperature Tt is the same (for example, 62° C.), the waiting process is not performed at the head temperature Th (for example, at 37° C. or 42° C.) and the normal printing process is performed, the waiting process is performed, or the waiting time is different. Conversely, even when the head temperature Th is the same (for example, 37° C.), the existence or non-existence of the waiting process or the waiting time is different at transistor temperature Tt (for example, 62° C. and 72° C.).

According to the condition table of FIG. 11, the use environment of the printer 1 is not made, when the head temperature Th is below −20° C. (first condition). Therefore, the printing process is stopped irrespective of the transistor temperature Tt. When the head temperature Th is above 70° C. (limit value) (seventh condition), the ejection failure occurs in the head 41 irrespective of the transistor temperature Tt. Moreover, since the head 41 may break down, the printing process is stopped.

When the head temperature Th is equal to or higher than −20° C. and lower than 35° C. (second condition), the ejection failure does not occur in the head 41. Therefore, the waiting process is not performed until the transistor temperature Tt exceeds a temperature (above 70° C. in FIG. 11) at which the transistors may break down. This condition is the threshold value condition in which the waiting process is performed only in consideration of the breakdown of the transistors caused due to the temperature increase of the transistors, since the ejection failure does not occur in the head 41. In addition, the threshold values for determining whether to perform the waiting process are “−20° C.” and “70° C.” and the threshold values for determining whether to stop the printing process are “−20° C.” and “85° C.”. In addition, according to threshold values “70° C.”, “75° C.”, “80° C.”, and “85° C.”, time for waiting the generation of the driving signal for the printing process is set to be different.

When the head temperature Th is equal to or higher than 35° C. and lower than 70° C. (third condition to sixth condition), the ejection failure may occur in the head 41. Therefore, the waiting process is more likely to be performed, compared to the case where the head temperature Th satisfies the second condition. For example, when the head temperature Th is 30° C. under the assumption that the transistor temperature Tt is 66° C., the waiting process is not performed. However, when the head temperature Th is 35° C., the waiting process is performed. In this way, it is easy to perform the waiting process by lowering the threshold value of the transistor temperature Tt for the waiting process as the head temperature Th is higher. With such a configuration, when the head temperature Th is high and the ejection failure may occur in the head 41, the generation of the driving signal for ink ejection is waited and the heat generation of the transistors (junction) is restrained. Then, the temperature of the air blowing in the inside of the printer from the fan 45 provided in the heat sink 44 is lowered, thereby restraining the head temperature Th from increasing. By restraining the head temperature Th from increasing, it is possible to prevent the ejection failure of the head 41.

As described above, since the air heated due to the heat radiation of the heat sink 44 blows in a direction of the head 41, the head temperature Th increases. That is, the head temperature Th increases due to an influence of the heat generation of the transistors. However, according to a situation of the printing process, it is easy for the head temperature Th to increase or it is difficult for the head temperature Th to increase, even when a heat generation temperature of the transistors (transistor temperature Tt) is the same. For example, since the head 41 forms an image while the head 41 moves in the movement direction in the printer 1 according to this embodiment, it is easy for the head temperature Th to increase in a case where the transistor temperature is high and the head 41 is located near the transistors. Conversely, when the transistor temperature is high and the head 41 gets away from the transistors, it is difficult for the head temperature Th to increase. That is, the head temperature Th increases under the influence of the heat generation of the transistors, but the head temperature Tt does not always increase constantly along with the heat generation of the transistors. That is, a relation between the transistor temperature Tt and the head temperature Th is not constant. In addition, not only the location in the movement direction of the head 41 but also a disturbance factor such as the use environment of the printer 1 affects the increase in the head temperature Th.

According to this embodiment, by managing both the head temperature Th and the transistor temperature Tt, it is possible to surely prevent the ejection failure in the head 41 and the breakdown of the transistors.

For example, as described above, the increase in the head temperature Th is relatively small, when the transistors generate heat but the transistors are located away from the head 41. Suppose that only the transistor temperature Tt is managed. At this time, the temperature increase of the head 41 is restrained and the temperature increase of the transistors is restrained, since it is expected that the head temperature Th increases in a case where the transistor temperature Tt increases. As a result, it is known that the waiting is longer. In this case, when the transistor temperature Tt increases but the increase in the head temperature Th is small, the waiting time becomes long unnecessarily, thereby causing the print time to be long. In order to avoid this problem, according to this embodiment, both the head temperature Th and the transistor temperature Tt are managed. Therefore, when the head temperature Th is a temperature at which the ejection failure does not occur, the waiting process is performed only for time necessary to restrain the temperature increase of the transistors (second condition in FIG. 11). As a result, since an unnecessary waiting process is not performed, it is possible to shorten print processing time as small as possible.

It takes time for the head temperature Th to increase due to the influence of the heated air, after the transistors generates heat, the heat is delivered to the heat sink 44, and the heated air passing through the hollow space 46 of the heat sink 44 is radiated. Therefore, when the head temperature Th increases, it is considered that there is a possibility that the transistor temperature Tt is lowered. In this case, the head temperature Th increases, but the transistor temperature Tt becomes a temperature at which the transistors do not break down. If only the transistor temperature Tt is managed and the transistor temperature Tt is the temperature in which the transistors do not break down, it is expected that the head temperature Th does not increase and thus it is known that the waiting process is not performed. In this case, when the head temperature Th increases but the transistor temperature Tt is lowered due to delay of the time until the head temperature Th increases due to the heat generation of the transistors, the waiting process is not performed. As a result, since the printing process continues to be performed without the waiting process and thus the head temperature Th further increases, the ejection failure occurs. In order to avoid this problem, according to this embodiment, both the head temperature Th and the transistor temperature Tt are managed. Therefore, when the head temperature Th is high but the transistor temperature Tt is a temperature at which the transistors do not break down, the waiting process is performed. Accordingly, it is possible to surely prevent the ejection failure caused due to the increase in the head temperature Th.

In sum, the threshold value of the transistor temperature Tt for the waiting process is determined on the basis of the head temperature Th according to Example 1. In addition, by lowering the threshold value so that it is easy to perform the waiting process as the head temperature Th is higher, it is possible to restrain the transistors from generating heat during the waiting process. In consequence, since the temperature of the air blowing in the direction of the head 41 by the fan 45 is lowered, the increase in the head temperature Th is restrained, thereby preventing the ejection failure of the head 41 and the breakdown of the head 41. Moreover, in the threshold value condition of the transistor temperature Tt determined on the basis of the head temperature Th, the time of the waiting process is configured to be longer as the transistor temperature Tt is higher. In consequence, by restraining the heat generation of the transistors during the waiting process, it is possible to prevent the breakdown caused due to the overheated transistors.

### Waiting Process:

### EXAMPLE 2

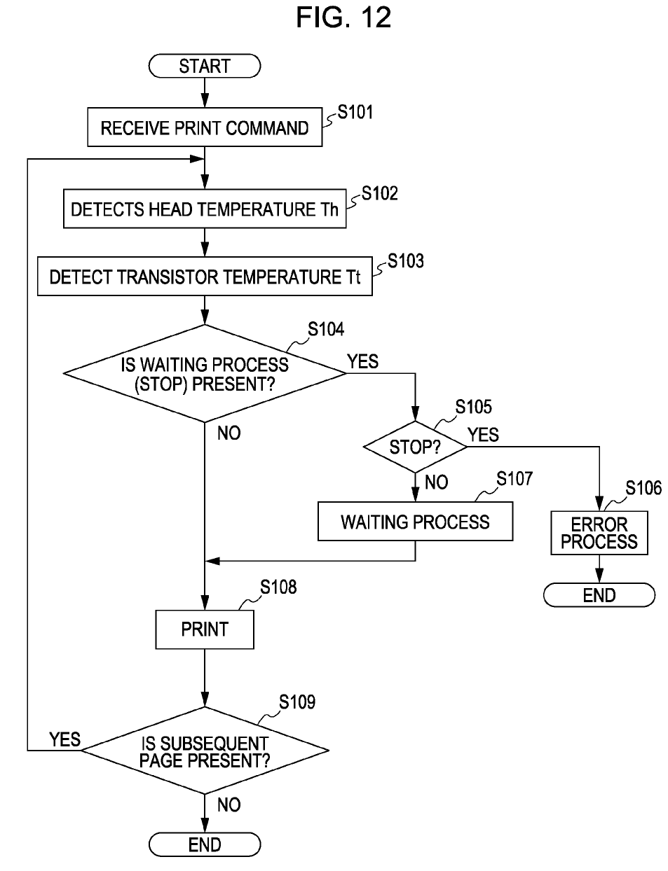

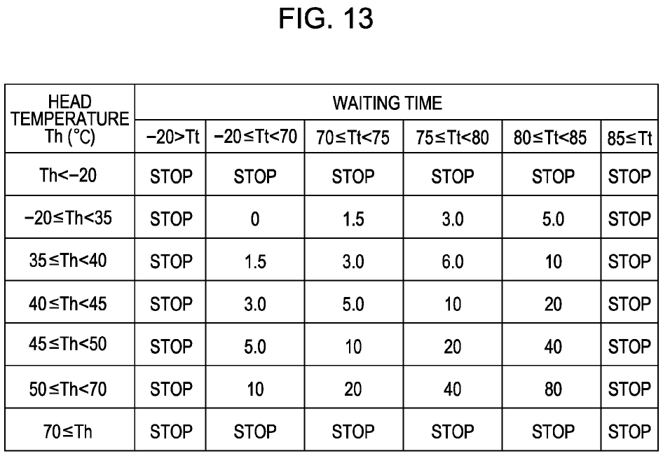

FIG. 12 is a flowchart illustrating a waiting process according to Example 2. FIG. 13 is a condition table of the waiting process according to Example 2. In Example 2, on the basis of the head temperature Th and the transistor temperature Tt, it is determined whether the driving signal generating circuit 70 performs the waiting process and a waiting time is determined.

First, when controller 10 receives a print command (S101), the head temperature Th is detected (S102) and the transistor temperature Tt is detected (S103). On the basis of the head temperature Th and the transistor temperature Tt, it is determined whether the waiting process is performed and the waiting time is determined from the condition table of FIG. 13. In Example 2, it is assumed that the waiting process is performed not in every pass as in Example 1 but in every page. When the waiting process is necessary (S104→Yes and S105→No), the generation of the driving signal for ink ejection is waited for predetermined time (S107) and then the printing process is performed (S108). Alternatively, when the waiting process is not necessary (S104→No), the printing process is immediately performed without performing the waiting process (S108). In this way, when the printing process corresponding to one page ends, the printing process is repeatedly performed until print data for a subsequent page is not present.

When at least one of the transistor temperature Tt and the head temperature Th is lower than −20° C., the printing process is stopped (S105→Yes) and then an error process is performed (S106). When the transistor temperature Tt is equal to or higher than a limit temperature (85° C.) at which the transistors break down if the printing process continues and when the head temperature Th is equal to or higher than a limit temperature (70° C.) at which the ejection failure occurs in the head 41, the printing process is also stopped.

According to the condition table of FIG. 13, when the transistor temperature Tt is a temperature (−20° C.≦Tt<70° C.) at which the transistors do not break down and when the head temperature Th is a temperature (−20° C.≦Th<35° C.) at which the ejection failure does not occur, the waiting process is not performed.

When the transistor temperature Tt is a temperature (−20° C.≦Tt<70° C.) at which the transistors do not break down but the head temperature Th is a temperature (35° C.≦Th<70° C.) at which the ejection failure may occur, the waiting process is performed. In addition, the waiting time is longer as the head temperature Th is higher. That is, when the head temperature Th is the temperature at which the ejection failure may occur, the waiting process is performed irrespective of the transistor temperature Tt (even when the transistor temperature Tt is low). By performing the waiting process, the heat generation of the transistor is restrained, thereby lowering the temperature of the air blowing in the direction of the head 41 by the fan 45. In consequence, by restraining the head temperature Th from increasing, it is possible to prevent the ejection failure from occurring.

Likewise, when the head temperature Th is the temperature (−20° C.≦Th<35° C.) at which the ejection failure does not occur but the transistor temperature Tt is a temperature (70° C.≦Tt) at which the transistors may break down, the waiting process is performed. In addition, the waiting time is longer as the transistor temperature Tt is higher. That is, when the transistor temperature Tt is the temperature at which the transistors may break down, the waiting process is performed irrespective of the head temperature Th (even when the head temperature Th is low). By performing the waiting process, it is possible to prevent the transistors from breaking down. [00107] Moreover, as the transistor temperature Tt approaches the temperature at which the transistors may break down and the head temperature Th approaches the temperature at which the ejection failure may occur, the waiting time is longer. [00108] As described above, the head temperature Th increases under the influence of the heat generation of the transistors, but a relation between the transistor temperature Tt and the head temperature Th is not constant depending on a situation of the printing process. Therefore, by managing both the transistor temperature Tt and the head temperature Th as in Example 2, it is possible to surely prevent the ejection failure of the head 41 and the breakdown of the transistors. Moreover, it is possible to prevent the print time from being longer due to the unnecessary waiting process.

### Waiting Process:

### EXAMPLE 3

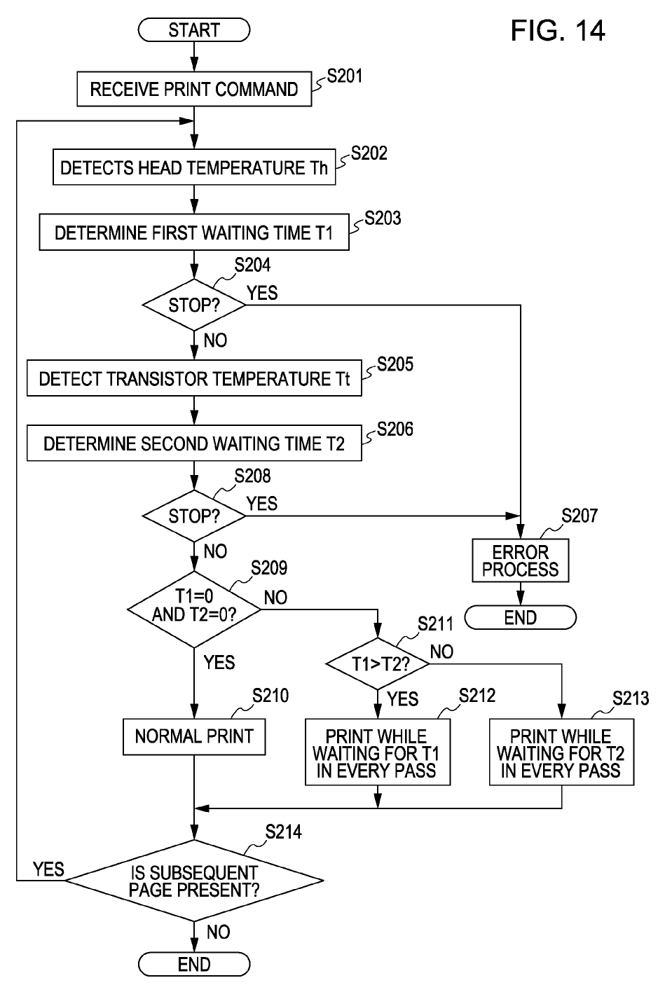

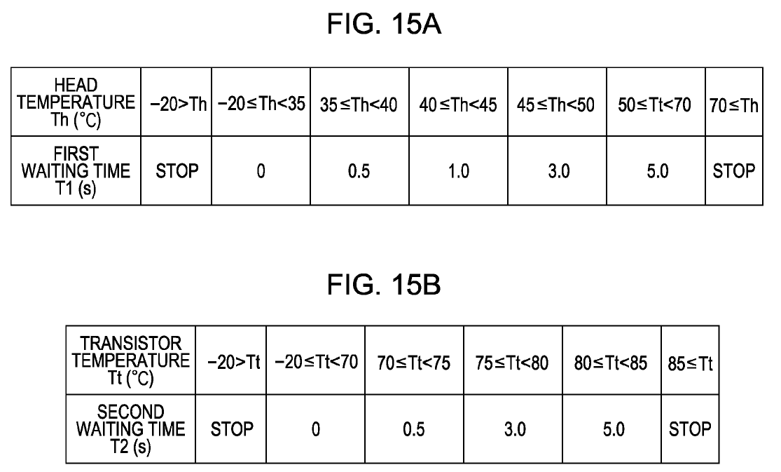

FIG. 14 is a flowchart illustrating a waiting process according to Example 3. FIG. 15A is a waiting condition table of the head temperature Th for the waiting process and FIG. 15B is a waiting condition table of the transistor temperature Tt. In Example 3, on the basis of the head temperature Th, waiting time (hereinafter, referred to as first waiting time T1) necessary for the ejection failure not to occur in the head 41 is determined. In addition, on the basis of the transistor temperature Tt, waiting time (hereinafter, referred to as second waiting time T2) necessary for the transistor not to break down is determined. In addition, the first waiting time T1 (corresponding to first waiting time) and the second waiting time T2 (corresponding to second waiting time) are compared to each other to wait the generation of the driving signal for ink ejection by the longer waiting time.

First, after a print command issued by a printer driver is received (S201), the head temperature Th is detected (S202). On the basis of the detection result of the head temperature Th, the first waiting time T1 for preventing the ejection failure of the head 41 is determined according to the waiting condition table of the head temperature Th shown in FIG. 15A (S203). At this time, when the head temperature Th is lower than −20° C. and the head 41 is not under a use environment or when the head temperature Th is a temperature (70° C.≦Th) at which the ejection failure is sure to occur if the printing process continues (S204→Yes), the printing process is stopped and the error process is performed without detecting the transistor temperature Tt (S207). Alternatively, when the printing process is not stopped (S204→No), the transistor temperature Tt is detected (S205). On the basis of the detection result of the transistor temperature Tt, the second waiting time T2 for preventing the transistor from breaking down is determined according to the waiting condition table of the transistor temperature Tt shown in FIG. 15B (S206). When the transistor temperature Tt is lower than −20° C. or is a limit temperature (85° C.≦Tt) at which the transistors break down (S208→Yes), the printing process is stopped and the error process is performed (S207).

In this way, when the first waiting time T1 and the second waiting time T2 are all zero after the determination of the first waiting time T1 and the second waiting time T2 (S209→Yes), the normal printing process is performed without the waiting process (S210). Alternatively, when at least one of the first waiting time T1 and the second waiting time T2 is not zero (S209→No), the first waiting time T1 and the second waiting time T2 are compared to each other (S211). After comparing the first waiting time T1 to the second waiting time T2, the generation of the driving signal for ink ejection is waited for the longer waiting time.

When the first waiting time T1 is longer than the second waiting time T2 (T1>T2), the printing process is performed while waiting for the first waiting time T1 in every pass (S212). Alternatively, when the second waiting time T2 is longer than the first waiting time T1 (T1<T2), the printing process is performed while waiting for the second waiting time T2 in every pass (S213). If the first waiting time T1 is equal to the second waiting time T2, the waiting process is performed for the time.

In this way, according to Example 3, both the head temperature Th and the transistor temperature Tt are managed. In addition, the waiting time necessary for the ejection failure not to occur in the head 41 is compared to the waiting time necessary for the transistors not to break down to wait the generation of the driving signal for ink ejection for the longer waiting time. With such a configuration, it is possible to surely prevent the ejection failure of the head 41 and the breakdown of the transistors. For example, when the first waiting time T1 (which is time for the ejection failure not to occur) is longer than the second waiting time T2 (which is time for the transistors not to break down), the generation of the driving signal for ink ejection is waited for the first waiting time T1. When the waiting process is performed for the first waiting time, the result that the waiting process is performed for the second waiting time is obtained. In consequence, it is possible to prevent the ejection failure and the breakdown of the transistors. If the waiting process is performed just for the shorter waiting time of the two waiting time T1 and waiting time T2, the ejection failure of the head may occur or the transistors may break down.

In Example 1 or 2, the existence or the non-existence of the waiting process or the waiting time is determined on the basis of the plurality of waiting conditions made by the relation between the head temperature Th and the transistor temperature Tt. However, in Example 3, the waiting condition for the head temperature Th is one (see FIG. 15A) and the waiting condition for the transistor temperature Tt is also one (see FIG. 15B). That is, the number of the waiting conditions is smaller and a memory capacity is more reduced in Example 3 than in Examples 1 and 2.

### Other Embodiments

In the above-described embodiment and examples, a printing system equipped with the ink jet printer has been described on the whole, but the method of restraining the head temperature from increasing and the like are also disclosed. In addition, it should be understood that the foregoing embodiment has been described for easy understanding of the invention and are not to be considered as limiting. The invention may be modified and improved without departing the gist of the invention and the equivalents of the invention are also included. In particular, embodiments described below are also included in the invention.

### Control of Transistor Temperature

In the above-described embodiment, both the transistor temperature Tt and the head temperature Th are managed, but the invention is not limited thereto. For example, only the head temperature Th may be managed to perform the waiting process only when the ejection failure may occur.

### Waiting Process

In the above-described embodiment, the waiting process is performed in every page or every pass, but the invention is not limited thereto. For example, it is determined whether the waiting process is performed in every plural pages. When the waiting process is necessary, the waiting process may be performed.

### Line Head Printer

In the above-described embodiment, the printer 1 performing the image forming process and the transport process in an alternative manner has been described as an example, but the invention is not limited thereto. For example, a line head printer in which nozzles are arranged across a sheet width in a direction intersecting the transport direction may be used.

### Liquid Ejecting Apparatus

In the above-described embodiment, the ink jet printer is exemplified as a liquid ejecting apparatus (as a part of liquid ejecting apparatus) realizing a liquid ejecting method, but the invention is not limited thereto. However, the invention may be realized in various apparatus for industrial use as well as the liquid ejecting apparatus. For example, the invention is applicable to a printing apparatus which attaches shapes on a cloth, a color filter manufacturing apparatus, a display manufacturing apparatus such as an organic EL display, a DNA chip manufacturing apparatus which applies a liquid dissolved with DNA to a chip and manufactures a DNA chip, a circuit board manufacturing apparatus, and the like.

The liquid ejecting method may be a piezo method of applying voltage to a driving element (piezo element) to expand or contract an ink chamber and eject a liquid and a thermal method of generating bubbles in nozzles using a heating element to eject a liquid by use of the bubbles.

When a controller within a printer instructs a waiting process as in the printer 1 according to the above-described embodiment, the printer 1 corresponds to the liquid ejecting apparatus. In addition, when a computer connected to a printer instructs a waiting process, a system in which the computer is connected to the printer corresponds to the liquid ejecting apparatus.

What is claimed is:

1. A liquid ejecting apparatus comprising:
a head which ejects a liquid in accordance with a driving signal;
a driving signal generator which generates the driving signal;
a sensor which detects the temperature of the head; and
a controller which allows the head to wait the liquid ejection performed in accordance with the driving signal on the basis of the detection result of the sensor.

2. The liquid ejecting apparatus according to claim 1, further comprising a fan which cools the driving signal generator heated due to the generation of the driving signal,
wherein the fan inhales air from the outside of the liquid ejecting apparatus.

3. The liquid ejecting apparatus according to claim 1, further comprising a generator sensor which detects the temperature of the driving signal generator,
wherein the controller allows the head to wait the liquid ejection performed in accordance with the driving signal on the basis of the detection result of the sensor and the detection result of the generator sensor.

4. The liquid ejecting apparatus according to claim 3,
wherein the controller determines first waiting time, which is time for waiting the liquid ejection from the head performed in accordance with the driving signal, on the basis of the detection result of the sensor and determines second waiting time on the basis of the detection result of the generator sensor, and
wherein the controller allows the head to wait the liquid ejection performed in accordance with the driving signal only for longer time of the first waiting time and the second waiting time.

5. The liquid ejecting apparatus according to claim 3, wherein the controller allows the head to wait the liquid ejection performed in accordance with the driving signal, when the detection result of the generator sensor exceeds a threshold value based on the detection result of the sensor.

6. The liquid ejecting apparatus according to claim 5, wherein the threshold value becomes lower as the detection result of the sensor becomes higher.

7. The liquid ejecting apparatus according to claim 3, wherein the generation of the driving signal by the driving signal generator is interrupted, when at least one of the detection result of the sensor and the detection result of the generator sensor exceeds a limit value.

8. A method of ejecting a liquid in a liquid ejecting apparatus which includes a head ejecting a liquid in accordance with a driving signal, a driving signal generator generating the driving signal, and a sensor detecting the temperature of the head, the method comprising:
detecting the temperature of the head; and
allowing the head to wait the liquid ejection performed in accordance with the driving signal on the basis of the detection result of the sensor.
